(19) United States
(12) Patent Application Publication
(10) Pub. No.: US 2005/0136375 A1
(43) Pub. Date: Jun. 23, 2005

(54) Method and apparatus to remove macro and micro debris from a root canal

(76) Inventors: Robert J. Sicurelli JR., Brooklyn, NY (US); Samuel Masyr, Brooklyn, NY (US)

Correspondence Address: ALFRED M. WALKER, 225 OLD COUNTRY ROAD, MELVILLE, NY, 11747-2712, US

(21) Appl. No.: 10/741,175

(22) Filed: Dec. 20, 2003

(51) Int. Cl. A61C 5/02

(52) U.S. Cl. 433/81; 433/102; 433/224

(57) ABSTRACT

An apparatus agitates fluid in a root canal of a living patient during cleaning of the root canal. The apparatus includes a tapered tip member having a proximate end and a distal end for insertion into said root canal. The tip member is vibrated or rotated by a driving device for the tapered tip member, which is connected at a proximate end for connection to the driving device. The tip member is made of an elastomeric, non-cutting material having a smooth surface or a textured surface of non-cutting elastomeric material. Optionally, the tip member may include abrasive particles impregnated therein, or coated thereon.

### FIELD OF THE INVENTION

The present invention relates to endodontic intracanal irrigation.

### BACKGROUND OF THE INVENTION

After the canal of a tooth is filed and shaped during the usual and customary debridement procedure, organic and inorganic materials are left on the walls of the canal and in recesses therein that are difficult to clean. Traditional methods, such as irrigation of the canal, have been shown to be effective at removing larger loose debris. However, smaller sized particles can be lodged on ledges or around curves in the canal, or burnished against the wall surfaces; these are not easily removed by traditional cleaning and irrigation methods.

Significant amounts of micro and macro debris inside the canal have been demonstrated in scanning electron microscope (SEM) studies after traditional methods of cleaning. Many times the debris is tenaciously attached to the canal walls and behind fins and ledges. Irrigation procedures which simply douche the canal have not produced acceptable results.

Accordingly, these irrigation methods have not been able to effectively remove the “smear layer” which is an organic and inorganic film-like structure that occludes the dentin tubules. It has been demonstrated that removing this smear layer allows better sealing and a higher degree of sterility.

Sonic and ultrasonic rotary and hand metal files and reamers abrade and cut the dentin and are used to shape the canal. Shavings and particles are not completely removed and cause blockages in the root canal and accessory canals. Therefore these instruments are dangerous and ineffective in passively removing debris and smear layer as they continue to cut and adversely reshape the canal.

A kinder and gentler device and method is needed to clean the root canal as a final step before the root canal is sealed with gutta percha or other root canal sealer.

### OBJECTS OF THE INVENTION

It is therefore an object of the present invention to provide a gentle but effective instrument which agitates liquid in a root canal during the cleaning phase thereof, without changing the shape of the walls, and is capable of scrubbing the canal walls.

### SUMMARY OF THE INVENTION

In keeping with these objects and others which may become apparent, the present invention includes a plastic tipped sonic or ultrasonic device that vibrates, oscillates or rotates, or in a motion combining some or all of these actions, fits into the root canal and is sized to reach the apex.

The tip member can be parallel sided, tapered, side vented, bristled, or contain any surface irregularity which would help dislodge debris. The tip member may be split in an axial direction or may be multi-stranded with free ends or be joined at the distal tip thereof. The crossection of the tip shape, as well as its surface texturing, is designed to be compatible with the motion regime of the driving device to which it is attached.

The tip member is made of one or more non-cutting plastics, such as aromatic polyamide (KEVLAR®) or nylon, but it can also be made of other semi-rigid elastomers, including flexible metals, such as nitinol.

The tip member gyrates, stirs, and otherwise evacuates the canal due to its fluid dynamic motion and its displacement or fluid dynamic action. The liquid already inside the canal helps to dissolve the smear layer and loosen debris. There is a displacement effect as the tip member is inserted into the liquid of the canal. The liquid may be saline, water, sodium hypochloride, or any of the traditional irrigants used in endodontic procedures, such as ethylidiamine-tetra acetic acid (EDTA).

The tip members are made in sizes and tapers commonly used in endodontics as cutting and shaping tools. A typical working length is 16 mm although commonly used sizes will vary from 15 mm to 35 mm.

Besides the various surface textures and characteristics mentioned above, tip members can also have varying degrees of flexibility. The tip members are constructed with appropriate straight or curved shafts and shaped ends, to fit on a variety of drive devices, such as contra angle and CAVITRON® devices commonly used in dentistry, consumer flossing drivers, or purpose-built drive devices.

Additionally, the working end of the tip members can be treated with medicaments that are eluted into the canal area when inserted and wetted. Liquid in the canal will dissolve and activate the medicaments that are impregnated on the tip members.

Accordingly, a polishing component can be applied to, or impregnated into, the tip member, which assists in removing the smear layer, without adversely changing the canal shape.

In a second embodiment of this invention, the working end of the plastic tip member is not a solid one-piece structure. In a first variation thereof, the working end is bifurcated longitudinally, forming an end with two parts. In the second variation thereof, three or more longitudinal slits are used to partition the end into three or more separate parts (trifurcated) emanating from a common shaft. A third variation thereof substitutes longitudinally extending multiple fiber strands with loose ends for the single working end. In a fourth variation thereof, fibers emanating from a common shaft (as in the latter design) are attached at the distal end such that loose fiber strands exist in between.

In a third embodiment of this invention, abrasive coatings are used to aid in removing the smear layer. Abrasive particles, such as zirconium or aluminum oxide, are factory impregnated into the surface or used as a filler of the plastic material itself. Alternatively, smooth plastic tip members or plastic tip members coated in silicone are dipped into an abrasive slurry just prior to use. The particles will imbed into the surface of the tip members.

### BRIEF DESCRIPTION OF THE DRAWINGS

The present invention can best be understood in conjunction with the accompanying drawings, in which:

FIG. 1 is a side elevation of a prior art consumer flossing device equipped with a novel plastic endodontic tip member of the present invention;

FIGS. 2A, 2B, 2C and 2D are side elevational views of four typical plastic tip members of the present invention, exhibiting four different surface treatments, wherein FIG. 2A shows a left-handed screw thread, FIG. 2B shows annular ridges, FIG. 2C shows a diamond pattern, and FIG. 2D shows stubbly bristle bumps;

FIGS. 2E, 2F and 2G are close-up side elevational detail views of alternate embodiments for fluid flow shield members located at the end caps of the tip members of the present invention, wherein FIG. 2E shows a concave fluid flow shield, 2F shows a convex fluid flow shield and FIG. 2G shows a flat fluid flow shield.

FIG. 3 is a side detail of a plastic tip member if the present invention, shown mounted on a contra angle driver;

FIG. 4 is a side elevational view of a plastic tip member of the present invention, shown mounted on an ultrasonic driver;

FIG. 5 is a side elevational view of a plastic tip member of the present invention, designed for use with an ultrasonic dental driver;

FIG. 6 is a side elevational view of a purpose-built driver, with an adjustable drive head, which can be rotated up to 90 degrees;

FIGS. 7A, 7B, 7C and 7D are side views of tip members of the second embodiment with multiple-element working ends, wherein FIG. 7A shows a bifurcated tip member, FIG. 7B shows a trifurcated tip member, FIG. 7C shows a tip member having fiber strands with loose ends and FIG. 7D shows a tip member having fiber strands with joined ends;

FIG. 8A is a close-up detail view in partial crossection of the distal end of a plastic tip member of the third embodiment, having factory applied impregnated abrasive particles;

FIG. 8B is a close-up detail view of the distal end in partial crossection of a plastic tip member; and, FIG. 9 is a close-up detail view in crossection of the distal end of a coated plastic tip member of the third embodiment, used with an abrasive slurry.

### DETAILED DESCRIPTION OF THE INVENTION

A typical prior art battery-driven flossing device offered by Water Pik® Technologies of Fort Collins, Colo. includes a driver which vibrates a short elastomeric flossing tip in two simultaneous orthogonal modes at about 167 Hz.

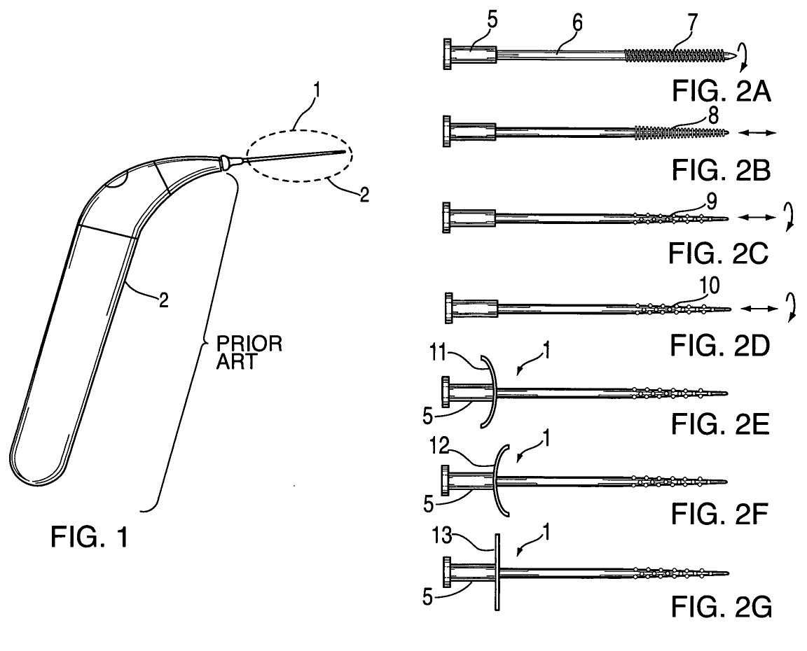

FIG. 1 shows such a device 2 equipped with novel plastic tip member 1 of the present invention, which is designed to couple in place of the flossing tip. Other standard vibrating, oscillating or rotating drivers used in the dental and endodontic professions may be also used.

FIGS. 2A, 2B, 2C and 2D show four different tip members 1 with straight shafts 6 and coupling ends 5, which are illustrated to fit the Water Pik® driver 2. Tip members 1 preferably have various surface texturing to agitate cleaning fluids and medicaments within the apical portion of a root canal of a tooth.

While tip members 1 shown in FIGS. 2A, 2B, 2C and 2D show textured surfaces thereon, it is also anticipated that tip members 1 may be optionally smooth and unencumbered by any surface texturization.

For interfacing with other devices, such as a contra angle, a different coupling end or just a plain shaft end may be required. The four tip members 1 illustrate four of many possibilities of surface treatment or molded texturing. For example, in FIG. 2A, a left handed spiral thread 7 pattern is used. This is most useful for a clockwise rotated tip member such as would be the case in a contra angle. The thread pattern would tend to pump liquid out of the root canal.

FIG. 2B shows an annular ring pattern 8 which can be vibrated linearly and/or moved linearly manually to dislodge particles; it is amenable to fabrication of softer elastomeric material.

FIG. 2C shows a diamond pattern 9 of short barbed protrusions, which would work with either rotary or linear vibration or both to effectively dislodge particles or remove the smear layer.

FIG. 2D shows a bump pattern 10 of short non-bristle rounded nib protrusions; they are effective at producing local scrubbing pressures against the canal wall in any vibratory mode even if molded of softer materials.

FIGS. 2E, 2F and 2G show alternate embodiments for fluid flow interruption shields 11, 12 and 13, located at the end caps of tie members 1. Each of the shields 11, 12 and 13 interrupt and catch fluid backwashing and splatter from the root canal being treated, to prevent the irrigant solution from entering and damaging the mechanical hand piece 2. The shields 11, 12, 13 also protect the patient and dental professional from fluid flow out of the root canal.

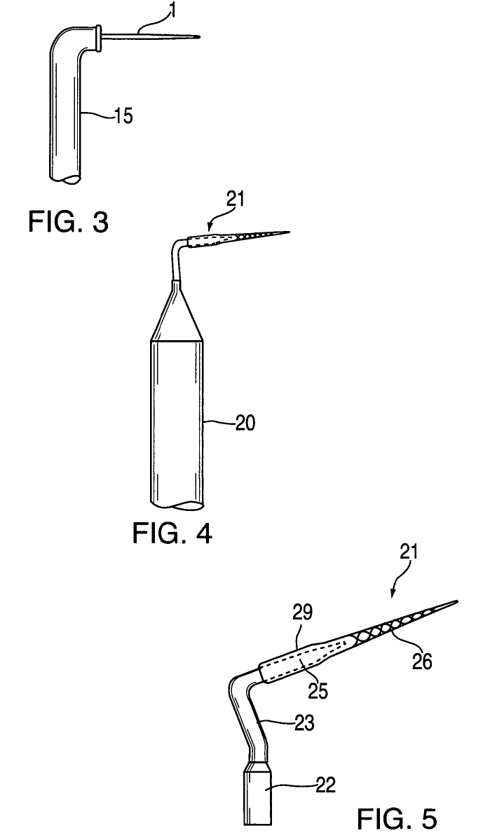

FIGS. 3 and 4 show two driver alternatives that are commonly used in dental work.

FIG. 3 shows plastic tip member 1 mounted to a contra angle dental drill driver which rotates tip member 1 in a constant clockwise direction.

FIG. 4 shows plastic tip member 21 fitted in an ultrasonic dental tool 20 of the CAVITRON® or OBTURA® type. The latter typically operates at 40 kHz.

FIG. 5 shows a plastic tip member 21 of this invention for use with an ultrasonic driver. Externally, it is shaped like a metallic cutting or shaping file tip member.

However, its working end 26 has a textured plastic surface. If desired, this tip member 21, like all other tip members 1 of this invention, can optionally be impregnated with medicaments.

Tip member 21 has an attachment end 22 which matches the requirements of the driving tool 20. A metal shank 23 bent with the proper shape is used for stiffness and to reduce the attenuation of the ultrasonic vibration. End 25 of the metallic shank is embedded in the shaft 24 of plastic tip member 21. This construction reduces the attenuation of the vibration by reducing the length of the totally plastic structure.

It is possible to extend the metallic core 25 further along the inside of working end 26 if it is somewhat flexible.

A soft elastomeric tip member is not compatible with the use of an ultrasonic driver unless supported with a stiffer core, such as a metallic core, to the distal end, since the ultrasonic vibrations will be absorbed in the material and heated by the vibration.

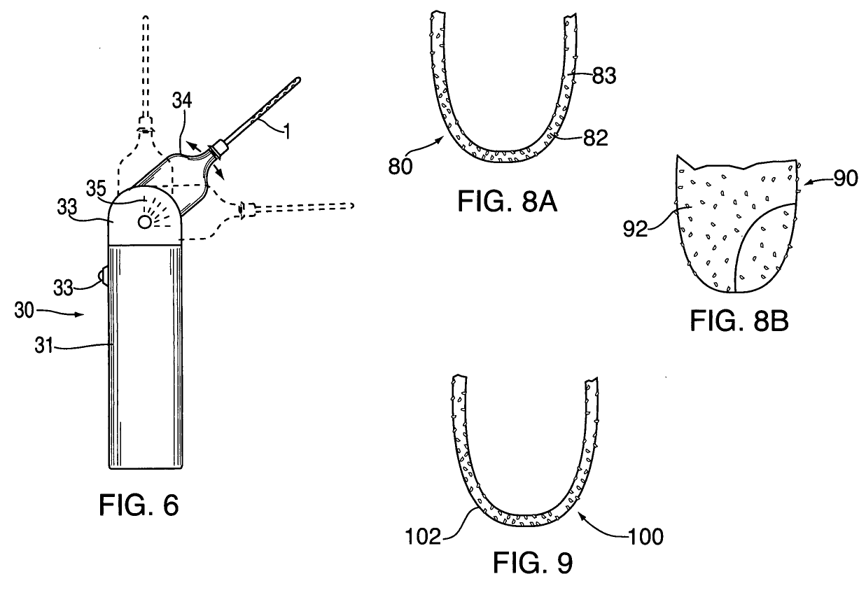

FIG. 6 shows a purpose-built driver 30 for tip members 1 of this invention. Handle 31 may be used as a battery housing if the driver head 34 is battery powered. Power head 34 may be a low frequency vibrator, an ultrasonic vibrator, or a rotary driver. It can be tilted as shown over a 90 degree range as “click-set” by internal grooves 35 mating with one or more ridges molded into the housing of power head 34. Grooves 35 are molded into the inside surfaces of resilient gimbals 33. Push button switch 32 controls the on/off operation.

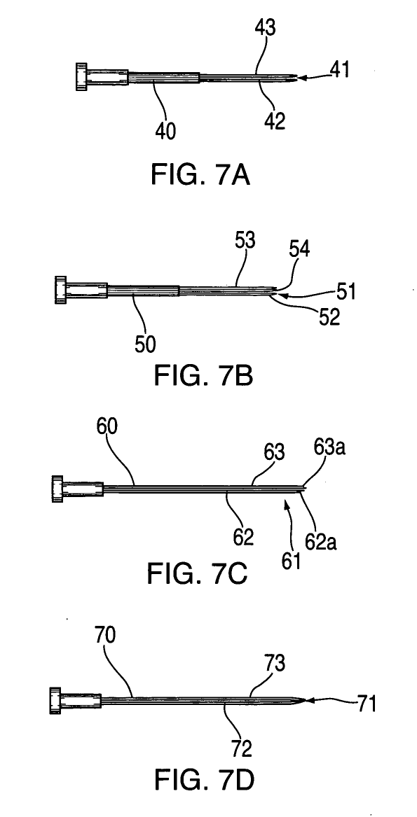

As shown in FIGS. 7A, 7B, 7C and 7D, the working end of the plastic tip member is not a solid one-piece structure. In the first variation of FIG. 7A, the working tip end 40 is bifurcated longitudinally, forming an end 41 with two side-by-side parts 42, 43. In the second variation of FIG. 7B, three longitudinal slits are used to partition the end 51 of working tip end 50 into three separate parts 52, 53, and 54 (trifurcated) emanating from the common shaft 50. A third variation of FIG. 7C substitutes multiple fiber strands 62, 63, etc. with loose ends 62a, 63a for the single working end 61 of a shaft 60. In a fourth variation, shown in FIG. 7D, fibers 72, 73, etc. emanating from a common shaft 70 (as in the latter design) are attached at the distal end such that loose fiber strands 72, 73, etc. exist in between.

In a third embodiment of this invention, abrasive coatings are used to aid in removing the smear layer within a root canal. Abrasive particle 82, such as zirconium or aluminum oxide, are factory impregnated into the outer surface 82 of a tip shaft 80, as in FIG. 8A or used as a filler 92 of the plastic material itself of tip shaft 90 as in FIG. 8B. Alternatively, as in FIG. 9 plastic tip members 100, or plastic tip members coated in silicone, are dipped into an abrasive slurry just prior to use. The particles 103 of the slurry 102 imbed into the surface of the tip members 100.

It is further noted that other modifications may be made to the invention, without departing from the scope of the appended Claims.

1. Apparatus for agitating liquid in a root canal of a living patient during cleaning of said root canal comprising:
a tapered tip member having a proximate end and a distal end for insertion into said root canal;
a driving device for said tapered tip member;
means on said proximate end for connection to said driving device; and
said tip member being of at least one non-cutting elastomeric material.

2. The apparatus of claim 1 in which said tip member has a smooth surface of said non-cutting elastomeric material.

3. The apparatus of claim 1 in which said tip member has a textured surface of said non-cutting elastomeric material.

4. The apparatus of claim 1 in which said non-cutting elastomeric material is plastic.

5. The apparatus of claim 1 in which said non-cutting elastomeric material is an aromatic polyamide (Kevlar).

6. The apparatus of claim 1, wherein said non-cutting elastomeric material is a flexible metal.

7. The apparatus of claim 1 in which said non-cutting elastomeric material is nylon.

8. The apparatus of claim 1 in which said non-cutting elastomeric material is a plurality of materials.

9. The apparatus of claim 1 in which said tip member is sufficiently flexible to conform to the shape of the root canal.

10. The apparatus of claim 1 in which said tip member is coated with a medicament.

11. The apparatus of claim 1 in which said tip member is impregnated with a medicament.

12. The apparatus of claim 1 in which said driving device is a latch-type dental device.

13. The apparatus of claim 1 in which said driving device is an ultrasonic driver.

14. The apparatus of claim 1 in which said driving device is a sub-ultrasonic device.

15. The apparatus of claim 1 in which said tip member has a metallic core extending to the distal end.

16. The apparatus of claim 1 in which said driving device is a vibrator.

17. The apparatus of claim 1 in which said driving device rotates.

18. The apparatus of claim 1 in which said driving device oscillates.

19. The apparatus of claim 1 in which said external surface has a configuration creating a hydrodynamic action.

20. The apparatus of claim 3 in which said textured surface has an alternating raised and lowered surfaces.

21. The apparatus of claim 3 in which said tip member has a spiral thread pattern.

22. The apparatus of claim 3 in which said textured surface has a left-handed screw thread.

23. The apparatus of claim 3 in which said textured surface of said tip member has an annular ring pattern.

24. The apparatus of claim 3 in which said textured surface is fluted.

25. The apparatus of claim 3 in which said textured surface of said tip member is in the form of a diamond shaped pattern.

26. The apparatus of claim 3 in which said textured surface is ribbed.

27. The apparatus of claim 3 in which said textured surface of said tip member comprises short protrusions of said non-cutting plastic material.

28. The apparatus of claim 1 in which said tip member is at least one axially extending member.

29. The apparatus of claim 1 in which said tip member is a plurality of axially extending tip members, separated by at least one respective axially extending division.

30. The apparatus of claim 29 in which said at least one axially extending division is at least one slot.

31. The apparatus of claim 30 in which said at least one slot is a plurality of slots.

32. The apparatus of claim 29 in which said plurality of tip members are joined at a distal end.

33. The apparatus of claim 28 in which said at least one axially extending tip member is a plurality of longitudinally extending fibers.

34. The apparatus of claim 3 in which said textured surface contains an abrasive polishing component.

35. The apparatus of claim 34 in which said abrasive polishing component is a dental abrasive.

36. The apparatus of claim 34 in which said abrasive polishing component includes abrasive particles coated upon said tip member.

37. The apparatus of claim 34 in which said abrasive polishing component include abrasive particles impregnated upon a surface of said tip member.

38. The apparatus of claim 34 in which said abrasive polishing component includes abrasive particles impregnated within said tip member.

39. The apparatus of claim 34 in which said abrasive component is a slurry including abrasive particles, wherein said tip member is dipped within said slurry, forming a coating thereon.

40. The apparatus of claim 1 further comprising a fluid flow interruption shield isolating and controlling back wash fluid flow splatter from within the root canal.

41. A method for agitating debris in a root canal of a living patient during cleaning of said root canal comprising the steps of:
connecting a proximate end of a tapered tip member to a driving device, said tapered tip member having a distal end, and said tip member having a surface of non-cutting elastomeric material;
inserting said distal end of said tapered tip member into said root canal; and
energizing said driving device to loosen macro debris within said root canal.

42. The method as in claim 40 wherein said driving device removes a smear layer within said root canal.

43. The method as in claim 40 further comprising the step of applying a textured surface to said tip member prior to insertion thereof into said root canal.
